(19) United States
(12) Patent Application Publication
(10) Pub. No.: US 2025/0287143 A1
(43) Pub. Date: Sep. 11, 2025

(54) IN-EAR MONITOR APPARATUS

(71) Applicant: Singularity Industries Inc., San Carlos, CA (US)

(72) Inventor: Matthew Leanse, San Carlos, CA (US)

(21) Appl. No.: 19/076,736

(22) Filed: Mar. 11, 2025

Related U.S. Application Data
(60) Provisional application No. 63/563,896, filed on Mar. 11, 2024.

(51) Int. Cl. H04R 1/28; H04R 1/10

(52) U.S. Cl. CPC H04R 1/2869; H04R 1/1016; H04R 1/1041; H04R 1/1075; H04R 2460/11

(57) ABSTRACT

An in-ear monitor apparatus includes: an electro-acoustic module; an internal sleeve; and a housing. The electro-acoustic module includes a front port configured to pass a front wave generated by an audio driver; a rear port configured to pass a back wave generated by the audio driver. The internal sleeve defines: a receptacle configured to receive and retain the electro-acoustic module; and a nozzle. The nozzle: extends between the receptacle and an audio outlet; and configured to pass the front wave from the receptacle to the audio outlet. The housing: is configured to contain the electro-acoustic module and the internal sleeve; cooperates with an external surface of the internal sleeve to define an internal back wave volume mechanically isolated from the nozzle by the internal sleeve; defines a back wave aperture configured to pass the back wave out of the housing.

### CROSS-REFERENCE TO RELATED APPLICATIONS

This Application claims the benefit of U.S. Provisional Application No. 63/563,896, filed on 11 Mar. 2024, which is hereby incorporated in its entirety by this reference.

### TECHNICAL FIELD

This invention relates generally to the field of electroacoustics and more specifically to a new and useful in-ear monitor apparatus in the field of electroacoustics.

### BRIEF DESCRIPTION OF THE FIGURES

FIGS. 1A, 1B and 1C are schematic representation of an in-ear monitor apparatus;

FIG. 2 is a schematic representation of an in-ear monitor apparatus;

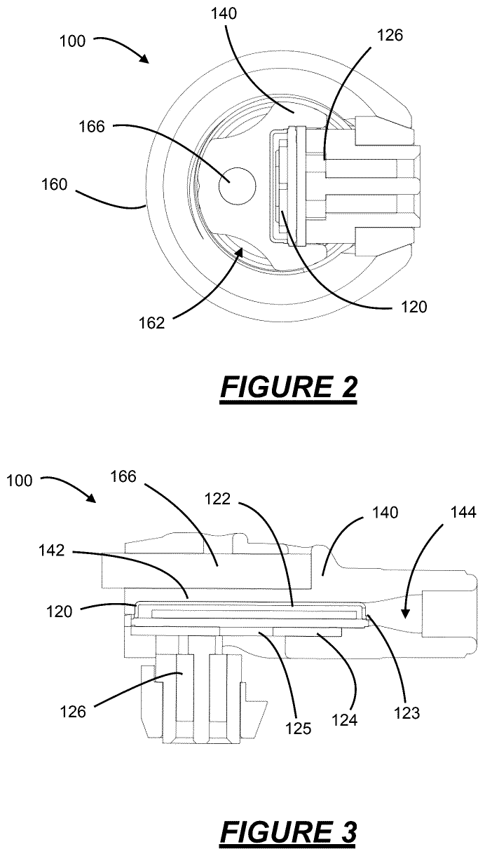

FIG. 3 is a schematic representation of an in-ear monitor apparatus;

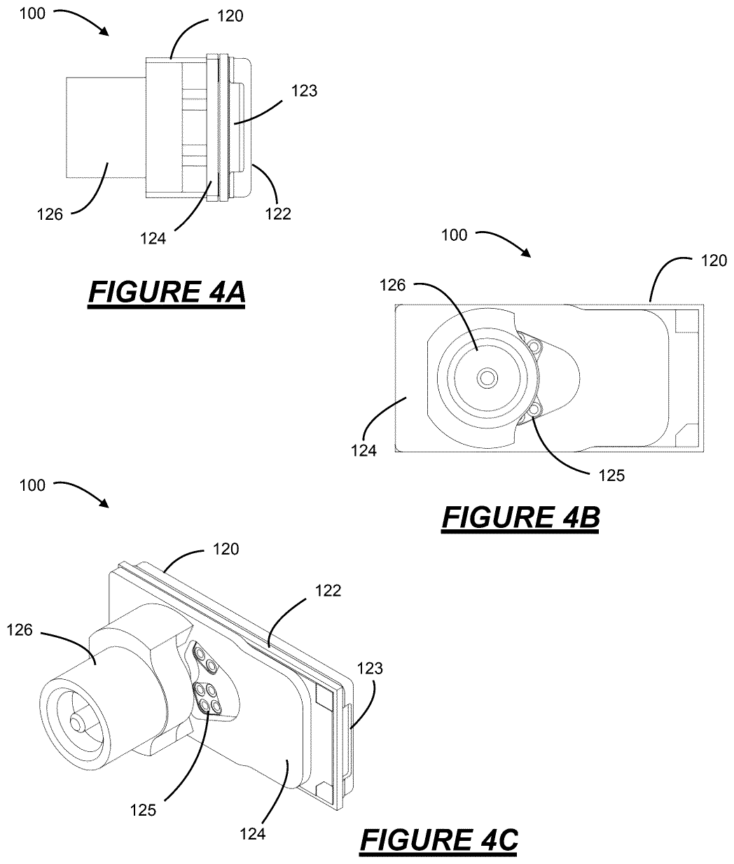

FIGS. 4A, 4B and 4C are schematic representations of an in-ear monitor apparatus;

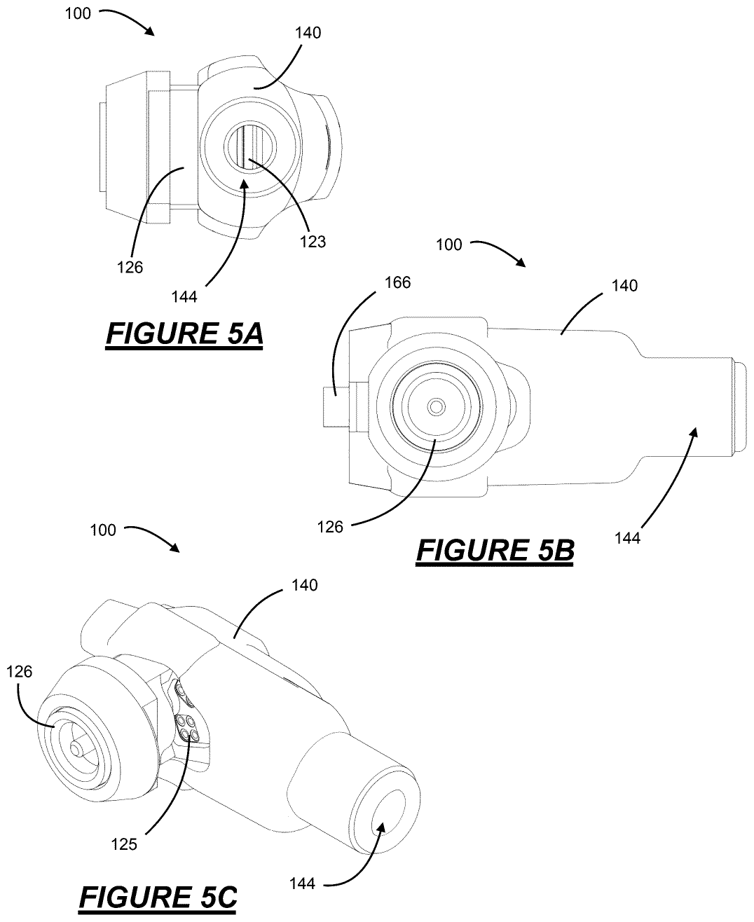

FIGS. 5A, 5B and 5C are schematic representations of an in-ear monitor apparatus; and

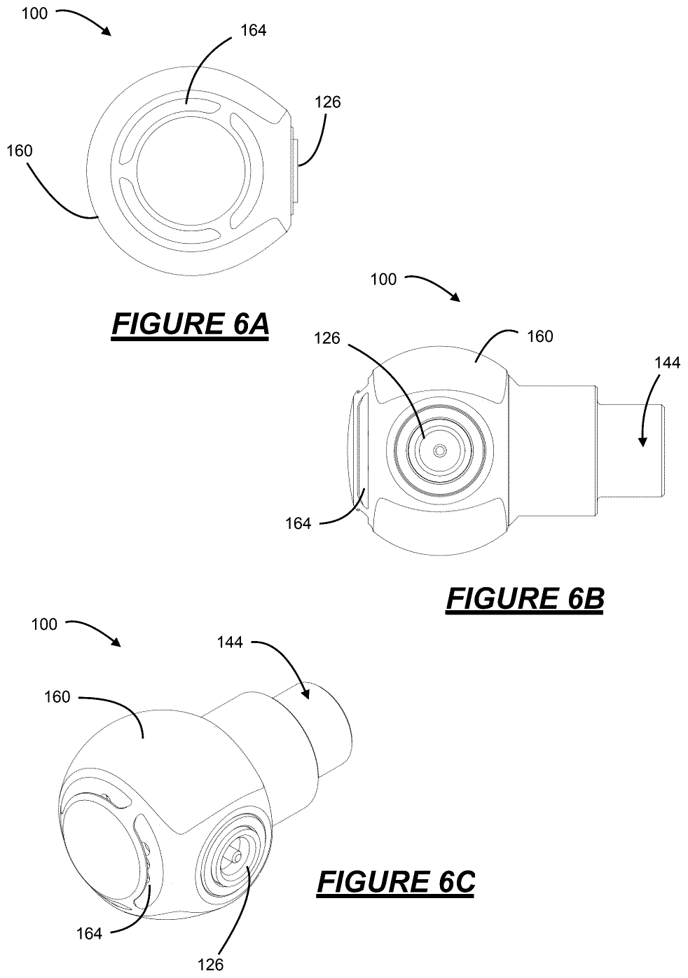

FIGS. 6A, 6B 6C, 6D and 6E are schematic representations of an in-ear monitor apparatus.

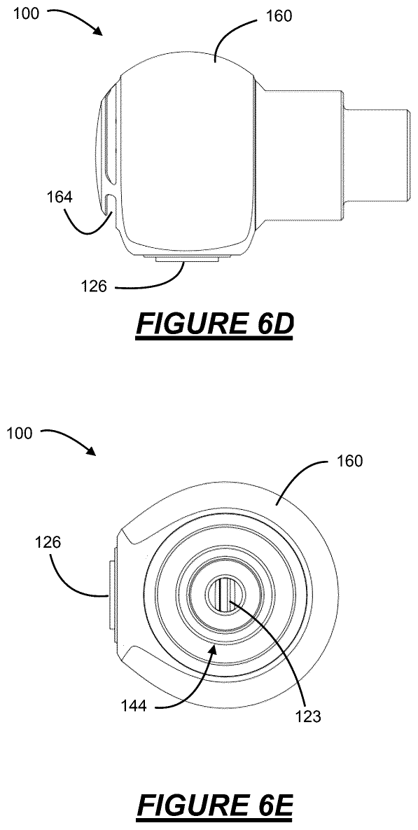

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Apparatus

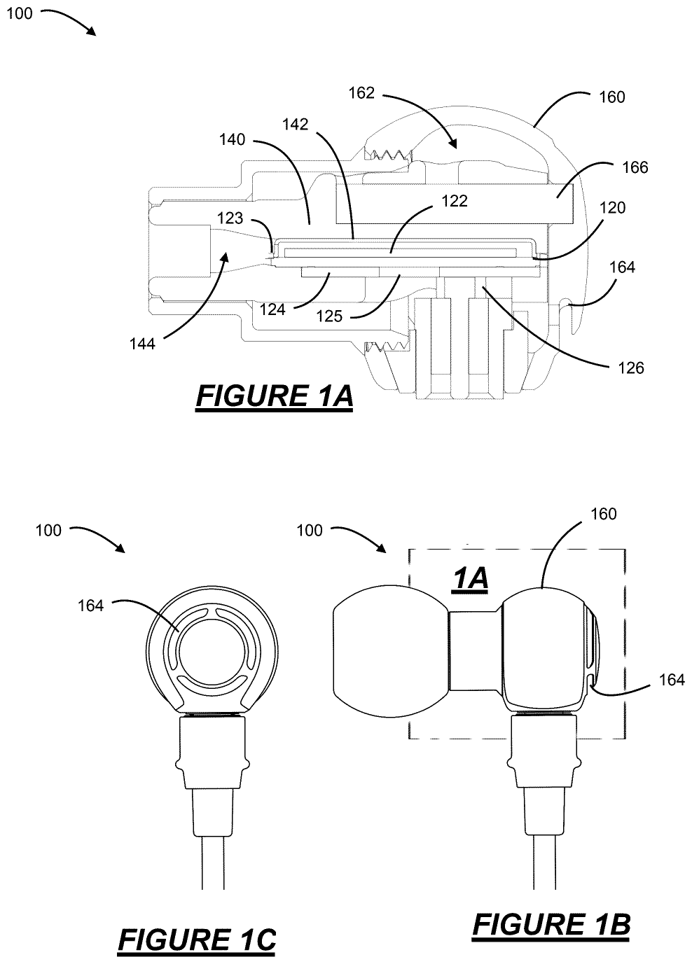

As shown in FIGS. 1A, 1B, and 1C, an in-ear monitor apparatus 100 includes: an electro-acoustic assembly 120; an internal sleeve 140; and a housing 160.

The electro-acoustic assembly 120 includes: an audio driver 122 (e.g., side-firing micro-electromechanical system speaker); a printed circuit board 124; and a connector 126 (e.g., a micro-miniature coaxial connector). The audio driver 122 includes a front port 123 configured to pass a front wave generated by the audio driver 122. The printed circuit board 124 is coupled to the audio driver 122 and includes: a rear port 125 configured to pass a back wave generated by the audio driver 122; and a set of solder pads arranged proximal the rear port 125. The connector 126 is coupled to the set of solder pads and defines a relief: adjacent the rear port 125; and configured to pass the back wave through the rear port 125.

The internal sleeve 140 defines a receptacle 142 and a front volume 144 (or “duct”). The receptacle 142 is configured to receive and retain the electro-acoustic assembly 120 (e.g., via a press-fit, interference-fit). The front volume 144: extends between the receptacle 142 and an audio outlet; and is configured to pass the front wave from the receptacle 142 to the audio outlet.

The housing 160 is configured to contain the electro-acoustic assembly 120 and the internal sleeve 140. The housing 160 defines an input aperture configured to receive and locate the connector 126 proximal an input region of the housing 160. The housing 160 also defines an output aperture configured to: receive and locate the audio outlet of the internal sleeve 140 proximal an output region of the housing 160; and locate proximal an ear of a user.

The housing 160 cooperates with an external surface of the internal sleeve 140 to define an internal back wave volume 162: extending annularly about the internal sleeve 140; and mechanically and acoustically isolated from the front volume 144 by the internal sleeve 140.

The housing 160 further defines a back wave aperture 164: opposite the audio outlet; intersecting the internal back wave volume 162; and configured to pass the back wave from the internal back wave volume 162 to an exterior of the housing 160.

### 2. Applications

Generally, an in-ear monitor apparatus 100 can function as a compact, low-profile wearable audio device configured to separate and contain acoustic waves (e.g., a front wave, a back wave) within distinct propagation paths to prevent or suppress destructive interference between these acoustic waves and maintain high-fidelity reproduction of an audio signal output by the in-ear monitor apparatus 100.

More specifically, the in-ear monitor apparatus 100 can: define a front propagation path for a front wave generated by an audio driver 122 (e.g., a micro-electromechanical system speaker) toward an audio outlet; and define a back propagation path—isolated from the front propagation path—generated by the audio driver 122 toward back wave apertures to minimize destructive interference between the front wave and the back wave and maintain high-fidelity sound reproduction of an audio signal at the audio outlet.

The in-ear monitor apparatus 100 can include an electro-acoustic assembly 120 configured to: couple to an audio source (e.g., a tablet, a laptop); and generate acoustic waves (e.g., a front wave and a back wave) based on an electrical signal representative of an audio waveform (e.g., music) received from the audio source (e.g., via a cable assembly). The electro-acoustic assembly 120 can include an audio driver 122 (e.g., a micro-electromechanical system speaker) including a front port 123 (e.g., side slit port) configured to pass the front wave. Additionally, the electro-acoustic assembly 120 further includes a printed circuit board 124 coupled to the audio driver 122 and defining a rear port 125—offset the front port 123—configured to pass the back wave. Furthermore, the in-ear monitor apparatus 100 can include an internal sleeve 140: configured to receive and retain the electro-acoustic assembly 120; and defining a front volume 144 to pass the front wave generated at the electro-acoustic assembly 120 toward an audio outlet.

Furthermore, the in-ear monitor apparatus 100 can include a housing 160 configured to conform to (or “fit within”) an ear of a user and locate the audio outlet of the internal sleeve 140 proximal an ear canal of the user. More specifically, the housing 160: contains the electro-acoustic assembly 120 and the internal sleeve 140; defines back wave apertures arranged opposite the audio outlet; and cooperates with an external surface of the internal sleeve 140 to define an internal back wave volume for passage of the back wave from the electro-acoustic assembly 120 towards the back wave apertures. As the back wave propagates through the internal back wave volume 162, the back wave reflects off the internal surface of the housing 160 and the external surface of the internal sleeve 140 resulting in diffusive wave interactions to: dissipate acoustic energy of the back wave and minimize interference between the back wave and the front wave; and/or substantially egress the back wave from the in-ear monitor apparatus entirely (e.g., via the back wave aperture).

Therefore, the in-ear monitor apparatus 100 can maintain acoustic isolation between the front wave and the back wave—generated at the electro-acoustic assembly 120—by defining independent propagation paths within a housing 160 that: impedes pressure variations within the internal back wave volume to support physical excursion of radiating surfaces of the audio driver in proportion to an input signal supplied to the audio driver 122; mitigates phase distortion effects that can induce destructive modulation of the audio signal at the audio outlet; and passes the back wave out of the housing (e.g., via the back wave apertures) to prevent residual acoustic energy from re-entering the front volume 144 and interfering with propagation of the front wave.

### 3. Electro-Acoustic Assembly+Acoustic Wave Generation

Generally, the in-ear monitor apparatus 100 includes an electro-acoustic assembly 120 configured to: generate acoustic waves (e.g., front wave, back wave) that represent an audio signal (e.g., music, live audio feed); and isolate these acoustic waves along discrete propagation paths to minimize interference between these acoustic waves and maintain high-fidelity sound reproduction of the audio signal.

In one implementation, the electro-acoustic assembly 120 includes a micro-electromechanical system speaker configured to generate acoustic waves in response to an electrical input signal, such as from an audio source (e.g., tablet, laptop). More specifically, the micro-electromechanical system speaker can emit a front wave corresponding to an audio signal (e.g., music) from a front port 123 of an acoustic chamber of the micro-electromechanical system speaker. In this implementation, the electro-acoustic assembly 120 further includes a printed circuit board 124: coupled to the micro-electromechanical system speaker; and defining a rear port 125 (e.g., a set of apertures) configured to pass a back wave—generated as an acoustic pressure wave resulting from diaphragm displacement within the acoustic chamber—toward an exterior of the electro-acoustic assembly 120.

Furthermore, the electro-acoustic assembly 120 can include a connector 126 (e.g., a micro-miniature coaxial cable): coupled to solder pads at the printed circuit board 124; defining a relief proximal the rear port 125 for unobstructed passage of the back wave output from the rear port 125; and configured to interface with a cable (e.g., coaxial cable) that supplies the audio signal—such as from the audio source—to the micro-electromechanical system speaker via the solder pads.

In one example, the micro-electromechanical system speaker includes a front port 123 (e.g., a slit) arranged at a lateral side of the micro-electromechanical system speaker. In this example, the printed circuit board 124: is coupled to a bottom end of the enclosure; and defines rear port 125s proximal a rear side of the micro-electromechanical system speaker configured to pass the back wave toward an exterior of the electro-acoustic assembly 120. Additionally, the connector 126 defines a demi-lune relief adjacent to the rear port 125 to maintain an open pathway for back wave propagation from the micro-electromechanical system speaker.

In another implementation, the electro-acoustic assembly 120 includes the audio driver 122 mechanically and electrically coupled to the connector 126, such as rigidly coupled to the connector 126, coupled parallel to the connector 126, directly coupled to the connector 126, and/or indirectly (e.g., via a printed circuit board) to the connector 126. In this implementation, the audio driver 122 includes: the front port 123; and the rear port 125.

Therefore, the electro-acoustic assembly 120 can define structural features that delineate distinct and non-interfering propagation paths for the front wave and the back wave generated by an audio driver 122 (e.g., a micro-electromechanical system speaker) to: minimize destructive interference between the front wave and the back wave; and maintain high-fidelity sound reproduction of an audio signal supplied to the electro-acoustic assembly 120.

### 3.1 Dual Drivers

In one implementation, the electro-acoustic assembly 120 includes a set of audio drivers 122 (e.g., identical drivers, a low-frequency driver and a high-frequency driver) configured to generate acoustic waves (e.g., front waves, back waves) based on a supplied audio signal. In this implementation, the electro-acoustic assembly 120 can implement the structure described above to define exclusive propagation paths for these acoustic waves.

### 4. Internal Sleeve: Front Volume+Back Wave Passage

Generally, the in-ear monitor apparatus 100 further includes an internal sleeve 140 configured to shape and isolate acoustic waves (e.g., a front wave, a back wave) output from the electro-acoustic assembly 120 along corresponding propagation paths to maintain wave integrity and suppress unintended dispersion of acoustic energy.

In one implementation, the internal sleeve 140 defines: a receptacle 142 configured to receive and retain the electro-acoustic assembly 120; a front volume 144 (e.g., a tapered front volume 144) extending between the receptacle 142 and the audio outlet (or “sound bore”); and a rear port 125 relief (e.g., aperture) arranged proximal the rear port 125 of the printed circuit board 124. In this implementation, the front volume 144 is configured to guide the front wave generated at the electro-acoustic assembly 120 along a controlled propagation path through the receptacle 142 and towards the audio outlet. Additionally, the rear port 125 relief of the internal sleeve 140 cooperates with the relief of the connector 126 to define a passage configured to pass the back wave generated at the electro-acoustic assembly 120 toward an exterior of the internal sleeve 140.

Furthermore, the front volume 144 can further include an acoustic filter (or “damping element”) configured to regulate a frequency response of the front wave by modifying airflow resistance and attenuating resonant peaks within the front volume 144.

In one example, the front volume 144: aligns with the front port 123 on the lateral side of the audio driver 122 to maintain a direct acoustic pathway from the receptacle 142 to the audio outlet; defines a contoured passage of a gradually constricting cross-section configured to reduce distortion and maintain clarity of the front wave propagating through the front volume 144 for high-fidelity acoustic reproduction of an audio signal at the audio outlet. In this example, the rear port 125 relief: is arranged on a bottom end of the internal sleeve 140 proximal the rear port 125 of the electro-acoustic assembly 120; cooperates with the relief of the connector 126 to define a duct (or “passage”) aligned with the rear port 125 configured to pass the back wave toward the exterior of the internal sleeve 140; and defines a contoured boundary that shapes wave characteristics (e.g., acoustic impedance matching, wave reflection control) of the back wave within the duct.

Therefore, the internal sleeve 140 defines dedicated pathways within the internal sleeve 140 to isolate propagation of the front wave within the front volume 144 from propagation of the back wave toward the exterior of the internal sleeve 140. Thus, the internal sleeve 140 can preserve acoustic fidelity of the front wave for reproduction of an audio signal at the audio outlet.

### 5. Housing

Generally, the in-ear monitor apparatus 100 further includes a housing 160 configured to: contain (or “house”) the electro-acoustic assembly 120 and the internal sleeve 140; and cooperate with the internal sleeve 140 to define an internal back wave volume 162 for dissipation of the back wave within the housing 160 to reduce interference between the back wave and the front wave.

### 5.1 Internal back Wave Volume

In one implementation, the housing 160 includes an internal surface that cooperates with the external surface of the internal sleeve 140 to define an internal back wave volume 162 extending annularly about the internal sleeve 140. Accordingly, the internal sleeve 140 can then maintain propagation of the back wave through this internal back wave volume 162. As the back wave propagates through the internal back wave volume 162, the back wave reflects off the internal surface of the housing 160 and the external surface of the internal sleeve 140 resulting in diffusive wave interactions to dissipate acoustic energy of the back wave and minimize interference between the back wave and the front wave. More specifically, the internal surface of the housing 160 and the external surface of the internal sleeve 140 define an acoustic boundary about an air gap configured to: attenuate acoustic energy (e.g., amplitude) of the back wave as the back wave interacts with impedance transitions at the internal surface of the housing 160 and the external surface of the internal sleeve 140; induce a phase cancellation effect through diffusive wave interactions that disrupt coherent reflections of the back wave; and maintain pressure equalization by distributing acoustic pressure variations of the back wave within the internal back wave volume 162.

In one example, the housing 160 includes a curved internal surface that cooperates with a curved external surface of the internal sleeve 140 to exclude internal parallel surfaces and define an internal back wave volume 162 extending annularly about the internal sleeve 140. The annular surfaces within the housing 160 are configured to disrupt uniform wavefront reflections of the back wave to reduce formation of standing waves and minimize reinforcement of frequencies interfering with propagation of the front wave within the front volume 144.

In another example, the external surface of the internal sleeve 140 cooperates with the internal surface of the housing 160 to form an internal back wave volume 162 that incorporates a Helmholtz resonator structure configured to regulate acoustic pressure and control resonance of the back wave within the housing.

Therefore, the housing 160 cooperates with the internal sleeve 140 to disrupt and scatter acoustic reflections of the back wave propagating through the internal back wave volume to: maintain acoustic separation between the back wave from the front wave propagating through the front volume 144 of the internal sleeve 140; and maintain a frequency response of the front wave propagating through the front volume 144 of the internal sleeve 140.

### 5.2 Venting+Back Wave

In one implementation, the housing 160 defines a set of back wave apertures 164 arranged about a periphery of the housing 160—opposite from the audio outlet—and configured to minimize pressure fluctuations within the internal back wave volume 162. In this implementation, each back wave aperture defines an acoustic pathway that intersects the internal back wave volume 162 of the housing 160 to an external environment in order to dissipate acoustic energy of the back wave—propagating within the internal back wave volume 162—by releasing residual acoustic pressure to prevent standing wave formations within the housing 160. As the back wave propagates through the internal back wave volume 162, the back wave: transitions impedance boundaries at the back wave aperture; propagates to an exterior of the housing 160 to reduce internal reflections of the back wave within the housing 160; and exhibits rapid pressure diffusion to minimize reinforcement of uncontrolled frequencies of the back wave within the housing 160.

In one example, the set of back wave apertures 164: define a series of elongated slots or circular perforations to regulate airflow and acoustic wave dispersion from the internal back wave volume 162; are arranged on the housing 160 opposite the audio outlet to pass the back wave away from the front wave path; and configured to control acoustic impedance at a boundary of each back wave aperture to manage wave dissipation within the internal back wave volume 162.

In another example, as described above, the external surface of the internal sleeve 140 cooperates with the internal surface of the housing 160 to form an internal back wave volume 162 that incorporates a Helmholtz resonator structure configured to regulate acoustic pressure and control resonance of the back wave within the housing 160. In this example, the set of back wave apertures 164 define a tunned acoustic pathway configured to regulate resonance characteristics and manage dissipation of the back wave.

Therefore, the set of back wave apertures 164 define propagation paths for dispersing the back wave along a trajectory opposite to propagation of the front wave (i.e., at the audio outlet) to prevent destructive interference between the front wave and the back wave.

### 5.3 Wires+Audio Signal Reproduction

In one implementation, the housing 160 defines structural features configured to support coupling between electrical components and an ear (e.g., a right ear, a left ear) of a user. In this implementation, the housing 160 can define an input aperture: configured to receive and locate the connector 126 proximal to an input region of the housing 160; including a recessed mounting interface that stabilizes the connector 126 during insertion and maintains electrical coupling to the electro-acoustic assembly 120; and configured to constrain cable positioning to prevent strain on internal electrical connections and minimize mechanical stress at the mounting interface. Additionally, the housing 160 can define an output aperture: configured to receive and locate the audio outlet of the internal sleeve 140 proximal to an output region of the housing 160; including a contoured surface profile that conforms to the ear of the user to maintain stability of the in-ear monitor apparatus 100 at the ear of the user; and configured to position the audio outlet proximal the ear of the user for direct transmission of the front wave toward into an ear canal of the user.

In one example, the input aperture: is arranged at a bottom end of the housing 160; and locates a primary connector 126 (e.g., a female micro-miniature coaxial connector) of the electro-acoustic assembly 120 that is configured to couple a secondary connector (e.g., a male micro-miniature coaxial connector) of the cable assembly. Accordingly, an audio source can then transmit an electrical signal representative of an audio waveform (e.g., music) to the electro-acoustic assembly 120 via the cable assembly. An audio driver 122 of the electro-acoustic assembly 120 can then generate a front wave and a back wave based on this electrical signal. In this example, the output aperture is arranged along a lateral side of the housing 160; and is configured to locate the audio outlet of the internal sleeve 140 proximal the ear of the user.

Accordingly, the housing 160 and the internal sleeve 140 cooperate to: isolate the back wave propagating within the housing 160 from the front wave propagating within the front volume 144; and maintain high-fidelity reproduction of the audio waveform at the ear of the user.

### 6. “Ship-in-a-Barrel” Assembly

In one implementation, the housing 160 includes: a primary housing section; and a secondary housing section that couples the primary housing section to contain the electro-acoustic assembly 120 and the internal sleeve 140.

For example, the primary housing section includes: the input aperture arranged at an input region of the primary housing section and configured to locate the connector 126 of the electro-acoustic assembly 120; and inner threads arranged about a coupling region of the primary housing section. Additionally, the secondary housing section includes: the output aperture arranged at the output region of the secondary housing section and configured to locate the audio outlet of the internal sleeve 140; and outer threads configured to couple the inner threads at the coupling region of the primary housing section to locate the electro-acoustic assembly 120 and the internal sleeve 140 within the housing 160.

During assembly of the in-ear monitor apparatus 100, the electro-acoustic assembly 120 and the internal sleeve 140 are inserted into the primary housing section to: locate the connector 126 of the electro-acoustic assembly 120 proximal the input region of the primary housing section; and couple the internal sleeve 140 to retention features arranged within the primary housing section. The secondary housing section is then coupled to the primary housing section to: rigidly locate the electro-acoustic assembly 120 and the internal sleeve 140 within the housing 160; and locate the audio output proximal the output aperture of the housing 160.

Therefore, the in-ear monitor apparatus 100 can include a two-part housing 160 defining interlocking structural features that rigidly locate internal components (i.e., the electro-acoustic assembly 120, the internal sleeve 140) within the two-part housing 160 with minimal fastening elements.

### 6.1 Acoustic Seal

In one implementation, the internal sleeve 140: can be formed (e.g., via three-dimensional printing) of an elastomeric material exhibiting damping characteristics that absorb mechanical vibrations, such as resulting from propagation of the back wave; and defines a seal about the audio driver 122 of the electro-acoustic assembly 120 to block acoustic leakage—from the audio driver 122 at electro-acoustic assembly 120—that can destructively interfere with the front wave propagating through the front volume 144. Additionally or alternatively, the internal sleeve 140 can include a sealant (e.g., fluoropolymer grease) cooperating with the elastomeric material to block acoustic leakage from the audio driver 122.

In one example, the internal sleeve 140 defines a unitary elastomeric element: configured to envelop the electro-acoustic assembly 120 and form a continuous barrier against acoustic leakage; defining apertures that permit the front wave to propagate through the front volume 144 and the back wave to vent through the rear port 125; and exhibiting elastomeric characteristics to absorb mechanical vibrations from the electro-acoustic assembly 120, isolate the electro-acoustic assembly 120 from shock associated with abusive handling of the in-ear monitor apparatus 100, and prevent distortion of the front wave propagating through the front volume 144.

Therefore, the internal sleeve 140 can: minimize acoustic leakage from the audio driver 122 of the electro-acoustic assembly 120 to maintain integrity of the front wave and the back wave; and cooperate with the electro-acoustic assembly 120 to define distinct propagation paths for the front wave and the back wave to block destructive interference and maintain fidelity of audio output at the audio outlet.

### 6.2 Insulating Ring

In one implementation, the in-ear monitor apparatus 100 includes an insulating ring configured to support mechanical coupling and electrical isolation between the electro-acoustic assembly 120 and the housing 160. The insulating ring: forms a sealed interface about the connector 126 of the electro-acoustic assembly 120; cooperates with an undercut taper (or “bore”) at the input region of the housing 160 to form an interference fit that rigidly retains and aligns the insulating ring to the housing 160; and is configured to block propagation of the back wave to the input region of the housing 160. More specifically, the insulating ring is configured to: maintain a nominal seal between the electro-acoustic assembly 120 and the housing 160 to minimize acoustic leakage of the back wave; and support pressure stabilization within the internal back wave volume by blocking airflow through the input region of the housing 160.

Accordingly, the insulating ring can define a dielectric barrier between the housing 160 and the electro-acoustic assembly 120 that: maintains electrical insulation under mechanical stress between the housing 160 and the electro-acoustic assembly 120; and maintains electrical signal transmission to the electro-acoustic assembly 120.

### 6.3 Bridge

In one implementation, the in-ear monitor apparatus 100 includes a bridge 166 configured to support stability and alignment of the electro-acoustic assembly 120 and the internal sleeve 140 within the housing 160. In this implementation, the internal sleeve 140 includes a slot (or “bore”) configured to receive and retain the bridge 166. The bridge 166 extends from the internal sleeve 140 and is configured couple to a bore arranged within the housing 160 to: constrain and structurally reinforce the electro-acoustic assembly 120 and the internal sleeve 140 within the housing 160, such as during application of external forces at the connector 126; maintain alignment of the electro-acoustic assembly 120 within the housing 160.

During assembly of the in-ear monitor apparatus 100, the bridge 166: locates within the bore of the housing 160 to form a mechanical interface between the housing 160 sections; and bends under shear stress during assembly of the two-part housing 160 to stabilize and reinforce the electro-acoustic assembly 120 and the internal sleeve 140 within the housing 160, such as to resist deflection under external forces (e.g., cable insertion, incidental torque, handling forces). The bridge 166 is configured to apply a compressive force to the housing 160 and the internal sleeve 140 to: compress the connector 126 against the insulating ring to acoustically seal the input aperture of the housing 160 and prevent acoustic leakage of the back wave from the internal back wave volume 162; compress the internal sleeve 140 against the housing 160 to acoustically seal the output aperture of the housing 160 and prevent acoustic leakage of the back wave from the internal back wave volume 162; and rigidly retain the electro-acoustic assembly 120 and the internal sleeve 140 within the housing 160 to prevent displacement of the electro-acoustic assembly 120 and the internal sleeve 140 during operation of the in-ear monitor apparatus 100.

Accordingly, the bridge 166 cooperates with the internal sleeve 140 and the housing 160 to: diffuse mechanical vibrations from the electro-acoustic assembly 120; reduce parasitic resonances by stabilizing the contact points between internal components within the housing 160; and minimize transmission of external shocks to the electro-acoustic assembly 120 to preserve consistent acoustic output at the audio outlet.

Therefore, the bridge 166: constrains movement of internal components within the housing 160 by maintaining positional integrity under external mechanical loads to prevent displacement of these internal components that can result in disruption of wave propagation and/or electrical continuity; and forms a localized damping interface that regulates vibrational energy transfer within the housing 160 to mitigate uncontrolled oscillations that can result in degradation of signal fidelity at the audio outlet.

### 7. Variation: Ventless Housing

In one variation, the in-ear monitor apparatus 100 excludes back wave apertures and defines structural features configured to regulate back wave propagation within a substantially enclosed internal back wave volume 162 of a housing 160. In this variation, the housing 160: cooperates with the internal sleeve 140 to define an internal back wave volume 162 that fully encloses the back wave to prevent uncontrolled acoustic leakage; includes a contoured internal surface to scatter back wave reflections and minimize standing wave formations within the internal back wave volume 162; and is configured to regulate internal air displacement and maintain acoustic stability of the back wave. Additionally, the housing 160 can: include an internal damping layer (e.g., porous foam, elastomeric baffles) configured to absorb acoustic energy and mitigate excessive wave reinforcement of the back wave; include a damping material adjacent to the rear port 125 of the electro-acoustic assembly 120 to attenuate back wave amplitude; implement an enclosure structure to minimize resonance buildup of the back wave within the housing 160. As the back wave propagates through the internal back wave volume 162, the back wave: reflects off the contoured internal surface of the housing 160 and the external surface of the internal sleeve 140 to scatter reflections of the back wave; transitions across impedance boundaries formed by damping layers and geometry of the housing 160 to gradually dissipate acoustic energy of the back wave; and transition across the damping material arranged adjacent to the rear port 125 of the electro-acoustic assembly 120 to attenuate residual wave amplitude of the back wave.

Therefore, the in-ear monitor apparatus 100 can include a housing 160 defining a fully enclosed internal back wave volume 162 configured to: contain and dissipate acoustic energy of the back wave without venting the back wave toward an exterior fourth the housing 160; and maintain pressure equilibrium within the housing 160 while preventing acoustic interference between the back wave and the front wave.

### 7.1 Variation: Plastic Housing

In one variation, the housing 160 includes: a primary housing section (e.g., a plastic housing section); and a secondary housing section (e.g., plastic housing section) bonded (e.g., adhesively bonded) to the primary housing section to contain the electro-acoustic assembly 120 and internal sleeve 140. In this variation, the primary housing 160 is bonded to the secondary housing 160 to: form a continuous external surface; and define an internal cavity that conforms to the external geometry of the internal sleeve 140 to maintain acoustic isolation between the front wave and the back wave.

In this variation, during assembly of the in-ear monitor apparatus 100, the electro-acoustic assembly 120 and the internal sleeve 140 are seated within a recessed cavity of a primary housing section. The secondary housing 160 is then aligned with a bonding region of the primary housing section to: enclose the electro-acoustic assembly 120 and the internal sleeve 140; and define the internal back wave volume 162 configured to pass the back wave. Additionally, an adhesive material is applied about the bonding region of the primary housing section and the secondary housing section to: from a seamless external enclosure; and from an acoustic seal between the housing 160 and the internal sleeve 140 to block acoustic leakage of the back wave from interfering with the front wave.

Therefore, the in-ear monitor apparatus 100 can include an adhesively bonded housing 160—containing the electro-acoustic assembly 120 and the internal sleeve 140—that: maintains an internal back wave volume 162 for controlled dissipation of a back wave; and eliminates mechanical discontinuities of the housing 160 that can result in disruption of acoustic wave propagation.

### 8. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatus 100es and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. An in-ear monitor apparatus comprising:
an electro-acoustic module comprising:
an audio driver comprising a front port configured to pass a front wave generated by the audio driver;
a printed circuit board coupled to the audio driver and comprising:
a rear port configured to pass a back wave generated by the audio driver to an internal back wave volume; and
a set of solder pads arranged proximal the rear port; and
a connector coupled to the set of solder pads;
an internal sleeve defining:
a receptacle configured to receive and retain the electro-acoustic module; and
a nozzle:
extending between the receptacle and an audio outlet; and
configured to pass the front wave from the receptacle to the audio outlet; and
a housing:
configured to contain the electro-acoustic module and the internal sleeve;
defining:
an input aperture configured to receive and locate the connector proximal an input region of the housing; and
an output aperture configured to:
receive and locate the audio outlet of the internal sleeve proximal an output region of the housing; and
locate proximal an ear of a user;
cooperating with an external surface of the internal sleeve to define the internal back wave volume:
extending annularly about the internal sleeve; and
mechanically isolated from the nozzle by the internal sleeve; and
defining a back wave aperture:
opposite the audio outlet;
intersecting the internal back wave volume; and
configured to pass the back wave out of the housing.

2. The in-ear monitor apparatus of claim 1, wherein the connector defines a relief:
adjacent the rear port; and
configured to pass the back wave from the rear port to the internal back wave volume.

3. An in-ear monitor apparatus comprising:
an electro-acoustic module comprising:
an audio driver comprising:
a front port configured to pass a front wave generated by the audio driver; and
a rear port configured to pass a back wave generated by the audio driver to an internal back wave volume;
a connector coupled to the audio driver;
an internal sleeve defining:
a receptacle configured to receive and retain the electro-acoustic module; and
a nozzle:
extending between the receptacle and an audio outlet; and
configured to pass the front wave from the receptacle to the audio outlet; and
a housing:
configured to contain the electro-acoustic module and the internal sleeve;
defining:
an input aperture configured to receive and locate the connector proximal an input region of the housing; and
an output aperture configured to:
receive and locate the audio outlet of the internal sleeve proximal an output region of the housing; and
locate proximal an ear of a user;
cooperating with an external surface of the internal sleeve to define the internal back wave volume:
extending annularly about the internal sleeve; and
mechanically isolated from the nozzle by the internal sleeve; and [symbol]
